(19) United States
(12) Patent Application Publication
(10) Pub. No.: US 2010/0000920 A1
(43) Pub. Date: Jan. 7, 2010

(54) Membrane coating for a water pressurization Bladder

(76) Inventors: Ermanno Martinello, Venaria Reale (TO) (IT); Mark Weih, Apex, NC (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 12/498,128

(22) Filed: Jul. 6, 2009

Related U.S. Application Data
(60) Provisional application No. 61/078,657, filed on Jul. 7, 2008.

(51) Int. Cl. B01D 71/24; B05D 3/10; B32B 25/04; B32B 9/04; B32B 27/00; B32B 27/36; B32B 27/30; B32B 27/40

(52) U.S. Cl. 210/137; 427/301; 428/492; 428/411.1; 428/423.9; 428/423.1; 428/335; 428/336

(57) ABSTRACT

A water pressurization system is shown having a metal tank with a tank interior which is divided into first and second fluid chambers by a flexible membrane. One side of the tank interior is pressurized by compressed air. The membrane has a special coating applied thereto which decreases the natural permeability of the rubber material which is used to form the membrane. By decreasing the permeability of the membrane material, wear and tear on the membrane is decreased. The possibility of deloading the tank interior of pressurized gas due to the membrane permeability is also lessened.

### CROSS-REFERENCE TO RELATED APPLICATIONS

The present application claims priority from the earlier filed provisional application, Ser. No. 61/078,657, filed Jul. 7, 2008, entitled “Water Pressurization System.

### BACKGROUND OF THE INVENTION

1. Field of the Invention

The present invention relates generally to pressure vessels of the type used in water pressurization systems and, more particularly, to such pressure tanks which include an elastomeric flexible membrane separating the interior of the tank into a compressible gas containing chamber and a liquid containing chamber.

2. Description of the Prior Art

Pressure control tanks are well known in the prior art and have been used in water supply systems, hot water heating systems and other types of water systems for many years. Generally, the tanks in such systems provide a needed quantity of pressurized water to the system upon demand, as in supplying drinking water for residential applications in potable water distribution systems. Such tanks are also used to allow expansion of the water within the system to avoid damage to pipes, valves, the system boiler, etc., in the case of a hot water heating system.

The pressure control tank used in these systems typically comprises a metal casing with a rubber membrane, sometimes referred to as a “bladder,” located within the tank interior. The two halves of the metal casing are attached, as by welding or formature edge metal, or in other convenient ways. The rubber membrane serves as a divider and creates two chambers within the tank interior. The first of the chambers contains water. The second chamber, formed by the external wall of the membrane and by the internal wall of the metal container, is occupied by compressed air. Water is supplied to the first chamber from a suitable supply source, such as a water well, or a municipal water line. The surrounding chamber is typically pre-charged with compressed air, either at the tank manufacturing plant, or by a technician during the tank installation.

As the pressure increases in the hydraulic circuit supplying water to the tank, there is an increase in the volume of water contained by the membrane. Consequently, there is a decrease in the volume of the chamber containing air and the consequent increase of pressure in the chamber itself counters the dilation of the membrane.

As the pressure in the hydraulic circuit decreases, the reverse process occurs, i.e., the greater pressure of the chamber containing air compresses the membrane, thereby restoring the water and energy previously accumulated in the hydraulic circuit.

As will be apparent from the discussion which follows, the rubber membrane works in abrasion against the metal of the tank interior and this action entails a wear on the material of the membrane over time. An additional significant factor which affects the useful life of the membrane is the phenomenon of osmosis, i.e., the permeability to air of the elastomer which is used to form the membrane. A small part of the air which is used to pre-charge the tank passes through the rubber of the membrane into the water, thus causing a higher amount of work, a greater abrasion, and greater anomalous deformations of the membrane itself as the level in the hydraulic circuit fluctuates. This phenomenon is increased the more the pre-charge and the switch-on pressure differ (i.e., the lower the pre-charge) and when the maximum pressure is higher than twice the minimum.

A need exists, therefore, for an improved membrane for use in such water pressurization systems, which membrane exhibits a greater useful life than currently available membranes.

A need also exists for such an improved membrane which exhibits decreased permeability to air than do the presently available materials from which the commercially available membranes are formed.

A need exists for such an improved membrane which can be made from readily available materials and using known manufacturing techniques, so that the end result is not cost prohibitive.

### SUMMARY OF THE INVENTION

The water pressurization system of the invention includes an expansion tank which is formed of metal and which has an internal membrane which divides the tank interior into a water chamber and a compressed air chamber. A source of water is supplied to the water side of the tank and a source of compressed air is used to pressurize the opposite side of the tank. The membrane which is used to separate the two chambers of the tank is a specially manufactured membrane which has a special coating which reduces the permeability of the material of the membrane to air. By reducing the air permeability of the membrane, the life of the membrane is extended.

The preferred coating for the membrane is a flexible, synthetic polymeric coating which can be selected from among various candidate materials including, aliphatic urethanes, hydrogenated nitrile butadiene rubbers (HNBR), fluoropolymers, chlorosulfonated polyethylenes, and chlorinated polymers and copolymers such as polyvinylidene chloride (PVDC) polymers and copolymers. When applied in very thin films, the polymeric coatings of the invention provide significant reductions in the permeability of the membrane to inert gases. The combination of the coating step, along with a suitable pretreatment step as described in the detailed description which follows, gives the necessary adhesion and permeability reduction that is not available from either step alone.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

Additional objects, features and advantages will be apparent in the written description which follows.

### BRIEF DESCRIPTION OF THE DRAWINGS

FIG. 1 is a simplified schematic of a water pressurization system of the invention, showing the membrane of the invention contained within the pressure tank of the system.

### DETAILED DESCRIPTION OF THE INVENTION

The present invention provides an improved membrane for use in a water pressurization system. The embodiments of the invention described herein and the various features and advantageous details thereof are explained more fully with reference to the non-limiting examples which are illustrated in the accompanying drawing and detailed in the following description. Descriptions of well-known components and processes and manufacturing techniques are omitted so as to not unnecessarily obscure the workings of the invention. The examples used herein are intended merely to facilitate an understanding of ways in which the invention herein may be practiced and to further enable those of skill in the art to practice the invention. Accordingly, the examples should not be construed as limiting the scope of the claimed invention.

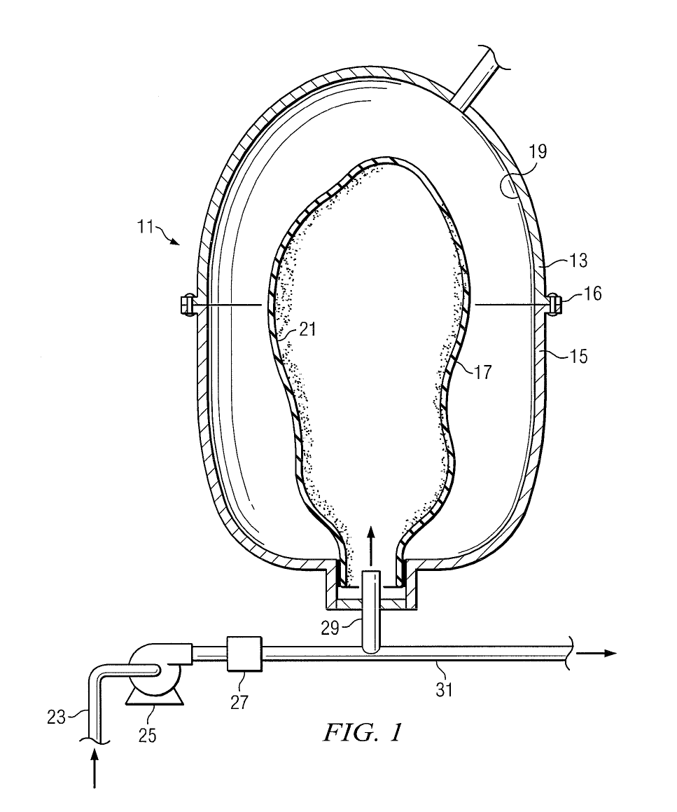

Turning to FIG. 1, there is shown a water pressurization system of the type used with the improved membrane of the invention. The system includes a metal tank 11 which is made from a top half 13 and a bottom half 15. The two halves are combined in any convenient fashion, as by welding, or the like at a juncture 16. A membrane 17 divides the tank into a top chamber 19 and a bottom or inner chamber 21. A suitable source of water 23 is communicated to the inner chamber 21 by a water pump 25. A pressure sensor 27 is located in the supply line prior to the water inlet 29. Water is discharged from the system through the outlet 31. In the past, the membrane 17 has typically been formed from a natural or synthetic rubber, e.g., styrene butadiene rubber (SBR). SBR is greatly appreciated in various industrial applications due to, among other factors, its elasticity. However, SBR has the disadvantage of being somewhat permeable to air. This can lead to premature wear and tear on the material of the membrane, as set out in the Background discussion above.

The workings of the present invention will now be described with reference to a typical water heating (boiler) system. It will be understood, however, that the same principles would apply to a potable water distribution system such as is used to supply drinking water to a residence. The expansion tank in a boiler system (heating system) must be designed to absorb the increase in volume of water which occurs when the water passes from room temperature to, e.g., 80° C. Thus, in a typical heating system, the vessel is loaded with a low air pressure so that the circuit water remains under pressure. When the boiler is turned on to heat water, this increases the volume of water. The water enters the tank, compressing the air, with the pressure increase being absorbed by the membrane. A typical boiler will work in this fashion some ten times a day.

In every temperature variation the corresponding variation in pressure is, to some extent, determined by the process of osmosis. The pre-loaded air passes through the wall of the membrane and exits through the water. As a result of this process of osmosis, the pre-loaded tank interior is in effect downloaded. The tank must then be recharged with air in order for the boiler to function properly. In Europe, the cost of this procedure ranges between about 20 Euro and 100 Euro, with the cost being partly determined by the amount of time the technician needs to travel to the boiler location.

While the above description relates to a boiler application, it will be appreciated that a variety of other potable water type applications exist in which a pressurized water system is needed. In many foreign countries, for example, the municipal water system is not sufficient to provide the water pressure required for normal household use. These types of applications would be ideal for the use of a system of the invention as described herein.

The present invention overcomes the problem of the permeability of the tank membrane by a special coating process. In the preferred method of the invention, an SBR membrane has a special polymeric coating applied which decreases the permeability of the SBR material. The coating is preferably applied just after the process of moulding the membrane, adding to the safety of the process. The technique of the invention solves the problem of permeability of the membrane at a very reasonable cost and without changing the underlying SBR material of the membrane, which is an excellent choice due to its other characteristics, such as its elasticity.

There are a number of factors which are important in a suitable coating composition for the present purpose. A strong bond between the rubber of the membrane body and the coating is crucial. The coating must not only provide good primary adhesion of the coating to the membrane exterior surface, but also be flexible enough to withstand the forces which are encountered in the field. The coatings which will be described below have been found to exhibit excellent abrasion and corrosion resistance, flexibility and toughness when applied to rubber substrates. They will also shield the rubber of the membrane body from chemical attack and from deterioration due to ozone or U.V. light exposure.

There are a number of characteristics for a suitable coating and a suitable coating process. These include:
the chemical characteristics of the rubber must be taken into account, because the membrane must accept the coating;
the temperature of application of the coating must be taken into account;
the concentration of the coating must be within a desired percentage range;
the coating is preferably sprayed with a system which will ensure a desired micron thickness of coating on the membrane surface;
the drying time of the coating must be determined in terms of time and temperature in order to arrive at the desired final coating.

The selected synthetic polymer is preferably a resilient elastomeric type compound which can be applied as a thin coating by spraying the underlying membrane. A number of different candidate coatings were evaluated in order to meet the above listed criteria. One coating is the synthetic polymeric coating described in U.S. Pat. No. 6,328,309, entitled “Pipe Belling Process Using Anti-friction Coating, issued Dec. 11, 2001. The preferred coatings described in that issued patent are fluoroplastic polymers and are used to coat sealing gaskets used in potable water applications. The gaskets are not used within a pressurized tank, as in the present application, however. Fluoroplastics are a class of paraffinic polymers that have some or all of the hydrogen replaced by fluorine. They include polytetrafluoroethylene, fluorinated ethylene propylene copolymer, perfluoroalkoxy resin, polychloro-trifluoroethylene copolymer, ethylene-tetra-fluoroethylene copolymer, polyvinylidene fluoride and polyvinyl fluoride. Fluoroplastics have a low coefficient of friction, especially the perfluorinated resins, giving them unique nonadhesive and self lubricating surface qualities.

Polytetrafluoroethylene (PTFE) is a completely fluorinated polymer manufactured by free radical polymerization of tetrafluoroethylene. With a linear molecular structure of repeating —CF2-CF3-units, PTFE is a crystalline polymer with a melting point of 327 degrees C. Density is 2.13 to 2.19 g/cc. PTFE's coefficient of friction is lower than almost any other known material. It is available in granular, fine powder (e.g., 0.2 micron), and water based dispersion forms. In the United States, PTFE is sold as “TEFLON” by Du Pont de Nemours Co. If utilized, the TEFLON coating is preferably applied by spraying on as a dry powder, followed by heating to fix or cure the coating. The techniques used can vary from conventional air atomized spray coating using a spray gun to such techniques as electrostatic deposition.

For electrostatic deposition, individual particles of polymer powder are statically charged and applied to the membrane surfaces, preferably at ambient temperatures. Even non-conductive surfaces can be coated using a variety of manual and automatic electrostatic application equipment including electrostatic air atomized, airless, air-assisted airless and rotary atomized powder particles arc negatively charged by either direct contact charging or by high voltage ranges from 60,000 to 120,000 volts with very low electrical currents (100 to 200 microamperes). The negatively charged particles seek a positively grounded object to satisfy the negative charge potential. The electrostatic force is so great that powder particles traditionally lost by overspray and bounceback from conventional air-atomized spray are attracted to the grounded part.

For electrostatics to be employed with rubber substrates, the rubber must be made conductive or appear conductive to the negatively charged particles. Methods which can be used to achieve this end include electrostatic prep coats on the rubber substrate, conductive primers, use of a grounded metal work holder beneath the part, using a rubber compound which has itself been made conductive or pre-charging the part.

After application of the dry powder to the substrate, the coated membranes of the invention will typically be heated, either reflectively or in an oven, to fix or set the coating. The exact temperature employed will depend upon the particular fluoropolymer chosen and the manufacturer's recommendation.

Another class of coating material is a synthetic polymer, preferably thermoplastic, most preferably a polyurethane high performance coating that will withstand severe temperature and abrasion. Polyurethane based coatings are commercially available and can be applied in the same basic manner as discussed above with respect to the TEFLON coatings. That is, they can be applied by spraying on at least selected external surfaces of the membrane followed by a drying period as recommended by the manufacturer. The spraying technique can be by conventional air atomized spray coating using a spray gun. The most preferred polyurethane coatings are aliphatic polyether urethanes. The polyurethane coatings generally exhibit inherent flexibility and energy absorbing properties needed for application to the membranes in question.

Another commercially available family of coatings useful for the purposes of the present invention are those coatings which are room temperature curing hydrogenated nitrile butadiene rubber (HNBR) based coatings which feature robust adhesion and exceptional mechanical properties. This family of coatings are composed of a mixture of polymers, organic compounds and fillers dissolved or dispersed in an organic solvent system. The HNBR based coatings have been found to exhibit a strong adhesion to substrate and elongation of up to 600%. Once properly applied, the coating does not crack or peel prior to substrate cracking. These coatings can be applied by spray, brush, dip or rolling coat methods and the coating can be easily incorporated into existing production lines. In addition to spraying, brushing or dipping the membrane substrate materials, the HBNR material can also be applied to the membrane by co-extruding the material as an extra external layer upon the gasket substrate. One preferred coating of this general class of coatings is sold commercially by Lord Chemical Company as the HPC 6C (HNBR) coating.

Another class of coating materials useful for the purposes of the present invention are the chlorosulfonated polyethylene coatings such as the HYPALON 48 coating sold commercially by E. I. Dupont de Nemours.

Another class of coating materials preferred for use in the present invention is made up of chlorinated polymers such as polyvinylidene chloride polymers and copolymers. Example commercial coatings of this general class include the DARAN 159 and DARAN 112 polyvinylidene chloride polymers sold by Owensboro Speciality Polymers, LLC, and the PERMAX 803 copolymer of polyvinylidene chloride and methacrylic acid sold by Lubrizol Advanced Materials.

The coating step will also be preceded by cleaning of the base substrate and by applying an adhesion promoter, as explained in the examples which follow.

The following test results are intended to be illustrative of the principles of the invention without being limited to the specific details thereof:

Example Permeability Data:

Test Protocol:

The basic test method is to use a European Standard DIN 4807 T3 to measure the permeability of air or nitrogen across a membrane. This consists of a steel chamber which can be pressurized with any gas. The chamber has at one end a metal grill with holes in it. The rubber membrane is placed between the grill and the body of the chamber. The chamber is outfitted with a sensitive pressure gauge and thermocouple. The entire assembly is then charged with an inert gas such as air or nitrogen to approximately 2 bar pressure, heated to a specific temperature, and then the transmission of the inert gas across the membrane is measured over a period of days. The percentage of the gas that is lost is then calculated for a 1 week exposure. This test procedure provides an objective comparison of the pressure loss or permeability of the bare membrane against a variety of coated membranes.

In the examples which follow, the test membrane always had a thickness of 2 mm, was either styrene-butadiene-rubber, or sometimes EPDM rubber, and was tested at various temperatures such as 15° C., 40° C., with air or nitrogen.

Specimen Preparation:

Each membrane was cleaned by immersion in hot alkaline cleaner DO-216 and D0-217 for 10′ at 85° C. from Quaisa, San Jose Costa Rica, rinsed in deionized water, and dried at 60° C. The dry membrane was then primed with an adhesion promotor based on a chlorinated polyolefin, CHEMLOK 459X from Lord Corporation. The CHEMLOK 459X was applied by spraying from a spray gun, dried at 60 C for 10′.

Without the application of the adhesion promoter none of the coatings had adhesion to EDPM or SBR rubber.

The cleaned, primed membranes were then coated with the specified coating by spray application to give a uniform coating of 25 to 50 microns, which was dried at 80° C. for 10′. The coatings were then baked for 5′ at 125° C.

### EXAMPLE I

A bare EPDM rubber membrane was placed in the test chamber, kept at 15° C., and with nitrogen pressurized at 2 bar. After 7 days of exposure, the chamber lost 0.8% of its charge.

### EXAMPLE II

An EPDM rubber membrane coated with HYPALON 48 (chlorosulfonated polyethylene 43% chlorine and 1.1% sulfur available from Dupont de nemours) was placed in the chamber at 15° C., 2 bars of nitrogen, and after 7 days of exposure, lost 0.42% of its charge. This represents a rate of loss of charge 1.9 times better than no coating.

### EXAMPLE III

A bare SBR rubber membrane at 15° C., with nitrogen pressurized at 2 bar, after 7 days of exposure lost 1.2% of its charge.

### EXAMPLE IV

An SBR rubber membrane at 15° C., with Nitrogen pressurized at 2 bar, and coated with a fluoropolymer coating, XYLAN 1237 from Whitford Corporation, after 7 days lost 0.96% of its charge. This is a rate of loss of charge 1.25 times better than no coating.

### EXAMPLE V

An SBR rubber membrane at 15° C., with nitrogen pressurized at 2 bar, and coated with an aliphatic polyether urethane coating V207, available from Lord Corporation, after 7 days lost 0.37% of its charge. This represents a rate of loss of charge 3.24 times better than the bare membrane.

### EXAMPLE VI

An SBR rubber membrane at 15° C., with nitrogen pressurized at 2 bar, and coated with a coating based on hydrogenated NBR rubber, HPC-6C, from Lord Corporation, after 7 days lost 0.34% of its charge. This represents a rate of loss of charge 3.52 times better than the bare membrane.

### EXAMPLE VI

An SBR rubber membrane at 40° C., with air pressurized to 2 bar, and no coating, after 7 days lost 3.3% of its charge.

### EXAMPLE VII

An SBR rubber membrane at 40° C., with air pressurized to 2 bar, with a polyvinylidene chloride polymer, DARAN 159 (Glass transition temperature 18-19C) from Owensboro Specialty Polymers LLC, after 7 days lost 0.7% of its charge. This represents a rate of loss of charge 4.7 times better than the bare membrane.

### EXAMPLE VIII

An SBR rubber membrane at 40° C., with air pressurized to 2 bar, coated with a polyvinylidene chloride polymer, DARAN 112 (Glass transition temperature 19-21C) from Owensboro Specialty Polymers LLC, after 7 days lost 0.8% of its charge. This represents a rate of loss of charge of 4.1 times better than the bare membrane.

### EXAMPLE IX

An SBR rubber membrane at 40° C., with air pressurized to 2 bar, coated with a polyvinylidene chloride-methacrylic acid copolymer, PERMAX 803 from Lubrizol Advanced Materials, after 7 days lost 0.9% of its charge. This represents a rate of loss of charge of 3.7 times better than the bare membrane.

### EXAMPLE X

An SBR rubber membrane at 40° C., with nitrogen pressurized to 2 bar, coated with a polyvinylidene chloride-methacrylic acid copolymer, PERMAX 803 from Lubrizol Advanced Materials, after 7 days lost 0.2% of its charge. This represents a rate of loss of charge of 16.5 times better than the bare membrane in air.

The “improvement” in rate of loss of charge from the above examples can be summarized as follows:

TABLE I

| Coating | Loss of Charge Ratios | |
|---|---|---|
| Chlorosulfonated polyethylene | 1.9 | times better than no coating |
| Fluoropolymer (XYLAN) | 1.25 | times better than no coating |
| Aliphatic Polyether Urethane | 3.24 | times better than no coating |
| Hydrogentated Butadiene Rubber | 3.52 | times better than no coating |
| Polyvinylidene Chloride | 4.7 | times better than no coating |
| (DARAN 159) | | |
| Polyvinylidene Chloride | 4.1 | times better than no coating |
| (DARAN 112) | | |
| Polyvinylidene Chloride-Methacrylic | 3.7 | times better than no coating |
| Acid Copolymer | | |
| Polyvinylidene Chloride-Methacrylic | 16.5 | times better than no coating |
| Acid Copolymer | | |

The improvement in rate of loss achieved is preferably greater than three times the rate of loss where no coating was applied. The preferred classes of coatings which achieved this ratio in the test runs were the aliphatic polyether urethane, the hydrogenated butadiene rubbers and the polyvinylidene chloride polymers and copolymers.

The most preferred classes of coatings were the polyvinylidene chloride polymers and copolymers.

It can thus be seen from the experimental data presented that the combination of rubber membrane with a properly applied coating selected from the group consisting of of fluoropolymers, aliphatic urethanes, HNBR, chlorosulfonated polyethylene, and chlorinated polymers and copolymers such as PVDC polymers and copolymers, applied in very thin films, leads to significant reductions in the permeability of the membrane to inert gases. The combination of the coating, along with a suitable pretreatment step, gives the necessary adhesion and permeability reduction that is not available form either alone.

While the invention has been shown in several of its forms, it is not thus limited but is susceptible to various changes and modifications without departing from the spirit thereof.

What is claimed is:

1. A pressure vessel for use in a water pressurization system, the pressure vessel comprising:
a tank body defining an enclosed tank interior;
a flexible elastomeric membrane separating the tank interior into a first and second fluid pressure chambers;
wherein the elastomeric membrane is formed from a natural or synthetic rubber which has a special coating applied thereto after manufacture of the membrane, which coating serves to decrease the permeability of the membrane to air.

2. The pressure vessel of claim 1, wherein the membrane is formed of styrene butadiene rubber.

3. The pressure vessel of claim 1, wherein the membrane is formed of EPDM rubber.

4. The pressure vessel of claim 1, wherein the tank is a part of a pressurized system used to supply drinking water to a structure.

5. The pressure vessel of claim 1, wherein the tank is a part of a water heating system which uses a boiler to provide hot water to one of the tank interior chambers, and wherein the membrane is used to accommodate changes in the water in the tank as the boiler is operated.

6. A pressure vessel for use in a water pressurization system, the pressure vessel comprising:
a tank body defining an enclosed tank interior;
a flexible elastomeric membrane separating the tank interior into a first and second fluid pressure chambers;
wherein the elastomeric membrane is formed from a natural or synthetic rubber which has a special coating applied thereto after manufacture of the membrane, which coating serves to decrease the permeability of the membrane to air; and
wherein the special coating is selected from the group consisting of aliphatic urethanes, hydrogenated nitrile butadiene rubbers (HNBR), fluoropolymers, chlorosulfonated polyethylenes, and chlorinated polymers and copolymers.

7. The pressure vessel of claim 6, wherein the coating is selected from the group consisting of polyvinylidene chloride (PVDC) polymers and copolymers.

8. The pressure vessel of claim 7, wherein the coating is applied as a thin film having a thickness in the range from about 25 to 50 microns.

9. The pressure vessel of claim 8, wherein the membrane is first treated with an adhesion promoter prior to being strayed with the thin film of coating.

10. The pressure vessel of claim 9, wherein the adhesion promoter is a chlorinated polyolefin.

11. The pressure vessel of claim 6, wherein treating the membrane with the coating produces a rate of loss of charge in a test vessel which is at least about three times less than the rate of charge observed with a membrane having no coating.

12. A method of manufacturing a membrane of the type used in a pressure vessel for use in a water pressurization system, the method comprising the steps of:
selecting a membrane base material which is formed from formed from a natural or synthetic rubber and which is properly sized to be received within an interior of the pressure vessel to divide the vessel interior into at least a gas compartment and a water compartment;
treating the membrane base material with a coating after manufacture of the membrane, which coating serves to decrease the permeability of the membrane to air.

13. The method of claim 12, wherein the wherein the coating is selected from the group consisting of aliphatic urethanes, hydrogenated nitrile butadiene rubbers (HNBR), fluoropolymers, chlorosulfonated polyethylenes, and chlorinated polymers and copolymers.

14. The method of claim 12, wherein the coating is selected from the group consisting of polyvinylidene chloride (PVDC) polymers and copolymers.

15. The method of claim 12, wherein the coating is applied as a thin film having a thickness in the range from about 25 to 50 microns.

16. The method of claim 12, wherein the membrane is first treated with an adhesion promoter prior to being strayed with the thin film of coating.

17. The method of claim 16, wherein the adhesion promoter is a chlorinated polyolefin.

18. The method of claim 12, wherein treating the membrane with the coating produces a rate of loss of charge in a test vessel which is at least about three times less than the rate of charge observed with a membrane having no coating.
